(19) United States
(12) Patent Application Publication
(10) Pub. No.: US 2014/0007892 A1
(43) Pub. Date: Jan. 9, 2014

(54) Acoustic Control Electronic Cigarette Case and Electronic Cigarette Device

(71) Applicant: Qiuming Liu, Shenzhen City (CN)

(72) Inventor: Qiuming Liu, Shenzhen City (CN)

(21) Appl. No.: 13/824,977

(22) PCT Filed: Jul. 3, 2012
(86) PCT No.: PCT/CN2012/078092

§ 371 Date: Mar. 18, 2013

(51) Int. Cl. G08C 23/02; A24F 15/00

(52) U.S. Cl. CPC G08C 23/02; A24F 15/00
USPC 131/329; 367/197

(57) ABSTRACT

This invention relates to an acoustic control electronic cigarette case and an electronic cigarette device. The electronic cigarette case comprises a battery device, an audio sensor, a memory module, an audio processing module connecting with the audio sensor and generating an electric detecting instruction during the predetermined period of time when the predetermined type acoustic signals is detected, an electric quantity detecting module, a display control module and a display module. The acoustic control electronic cigarette case and the electronic cigarette device of the present invention through disposing the audio sensor, the audio processing module generating an electric detecting instruction during the predetermined period of time when the predetermined type acoustic signals is detected, the electric quantity detecting module, the display control module and the display module achieve technical effects of being easily and conveniently to display the electric quantity, durable, and rapidly response.

### TECHNICAL FIELD

The present invention relates to a technical field of an electronic cigarette, and especially to an acoustic control electronic cigarette case and an electronic cigarette device.

### DESCRIPTION OF BACKGROUND

An electronic cigarette is a kind of simulating cigarette which heat and atomize materials having flavors through heating wire to generate smoke for users' suction. An electronic cigarette case for accommodating at least one electronic cigarette generally comprises a case body and a rechargeable battery disposed in the case body. When users do not smoke, the at least one electronic cigarette is put in the electronic cigarette case and recharged through a battery so as to assure that the at least one electronic cigarette has enough electric quantity for using. Therefore, users need to know a remaining charge of a battery at any moment.

An existing electronic cigarette case displays a remaining charge via a mechanical switch pressed by hands or other similar operation. In addition, a service life of the mechanical switch is short and easily be pressed to result in misoperation.

### SUMMARY

An object of the present invention is to solve existing problems and to provide an acoustic control electronic cigarette case and an electronic cigarette device which easily and conveniently to display the electric quantity, durable, and rapidly response.

To achieve the above objects, inventive embodiments of the present invention provide an acoustic control electronic cigarette case comprising a battery device disposed therein. The acoustic control electronic cigarette case further comprises an audio sensor for detecting external acoustic signals, a memory module storing a predetermined period of time, and a relation table of electric quantity and display parameters, an audio processing module connecting with the audio sensor and generating an electric quantity detecting instruction during the predetermined period of time when acoustic signals met with predetermined conditions are detected, an electric quantity detecting module connecting with the audio processing module and the battery device, and detecting the electric quantity of the battery device based on the electric quantity detecting instruction, a display control module connecting with the electric quantity detecting module and the memory module for generating a display instruction according to the electric quantity detected by the electric quantity detecting module matched for the relation table, a display module connecting with the display control module for displaying the electric quantity based on the display instruction.

Furthermore, the acoustic signals met with the predetermined conditions are invariable, continually strengthening, continually weakening, intermittently strengthening or intermittently weakening acoustic signals.

Furthermore, the audio processing module comprises a timing sub-module connecting with the memory module for counting time based on the predetermined period of time, and a determining sub-module connecting with the audio sensor and the timing sub-module for determining whether the acoustic signals are met with predetermined conditions during the predetermined period of time.

Furthermore, the display module is a liquid crystal display (LCD) screen or multiple light-emitting diodes (LEDs).

Furthermore, the acoustic control electronic cigarette case further comprises a light guide plate mounted at outside of the LEDs.

Furthermore, the acoustic control electronic cigarette case further comprises a case body comprising a bottom case and a case cover movably connected with the bottom case.

Furthermore, the acoustic control electronic cigarette case further comprises a frame device and a printed circuit board (PCB). The frame device comprises a cartridge tray, a cartridge frame and a base. The cartridge tray matches with the cartridge frame to accommodate a cartridge of at least one electronic cigarette. The battery device and the PCB are fixed by the base.

Furthermore, the battery device is a case battery and/or a cigarette rod battery. The battery device electrically connects the PCB via a battery connector.

Furthermore, a microprocessor is disposed on the PCB. The memory module, the audio processing module, and the display control module are integrated on the microprocessor.

Furthermore, a charging interface is disposed on the PCB for charging the battery device via an external power.

Correspondingly, the present invention provides an electronic cigarette device comprising the aforesaid electronic cigarette case and the cartridges and at least one battery rod accommodated in the electronic cigarette case.

Beneficial effects of the acoustic control electronic cigarette case and the electronic cigarette device of the present invention are: easily and conveniently to display the electric quantity, durable, and rapidly response via disposing the audio sensor, the audio processing module generating an electric detecting instruction during the predetermined period of time when the predetermined type acoustic signals is detected, the electric quantity detecting module, the display control module, and the display module to achieve the above-mentioned technical effects.

### DESCRIPTION OF THE DRAWINGS

FIG. 1 is a perspective view of an acoustic control electronic cigarette case in accordance with an embodiment of the present invention.

FIG. 2 is a cross-sectional view taken along the line A-A in FIG. 1.

FIG. 3 is a cross-sectional view taken along the line B-B in FIG. 1.

FIG. 4 is an exploded schematic view of the acoustic control electronic cigarette case shown in FIG. 1.

FIG. 5 is an exploded view of an electronic cigarette device in accordance with an embodiment of the present invention.

FIG. 6 is a theory drawing of the electronic cigarette device in accordance with an embodiment of the present invention.

### DETAILED DESCRIPTION OF THE EMBODIMENTS

It is required to explain that, without any confliction, embodiments of the present invention and features thereof can be combined, and are further described in detail in cooperation with drawings and physical examples as follows.

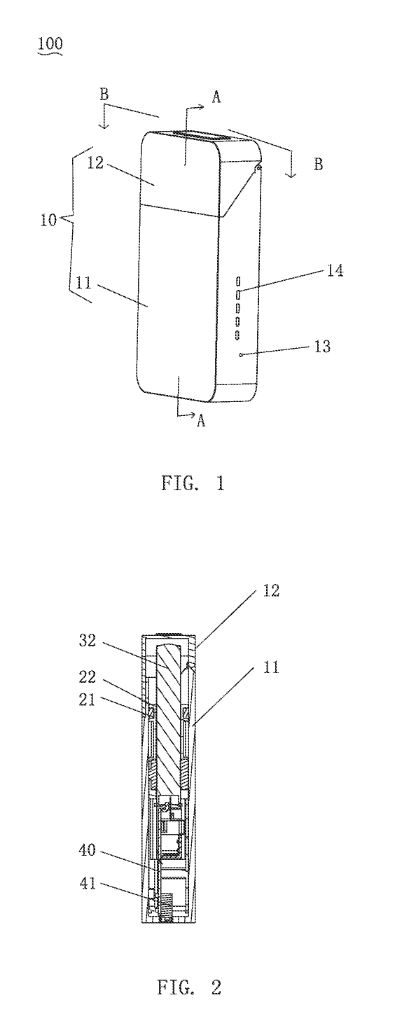

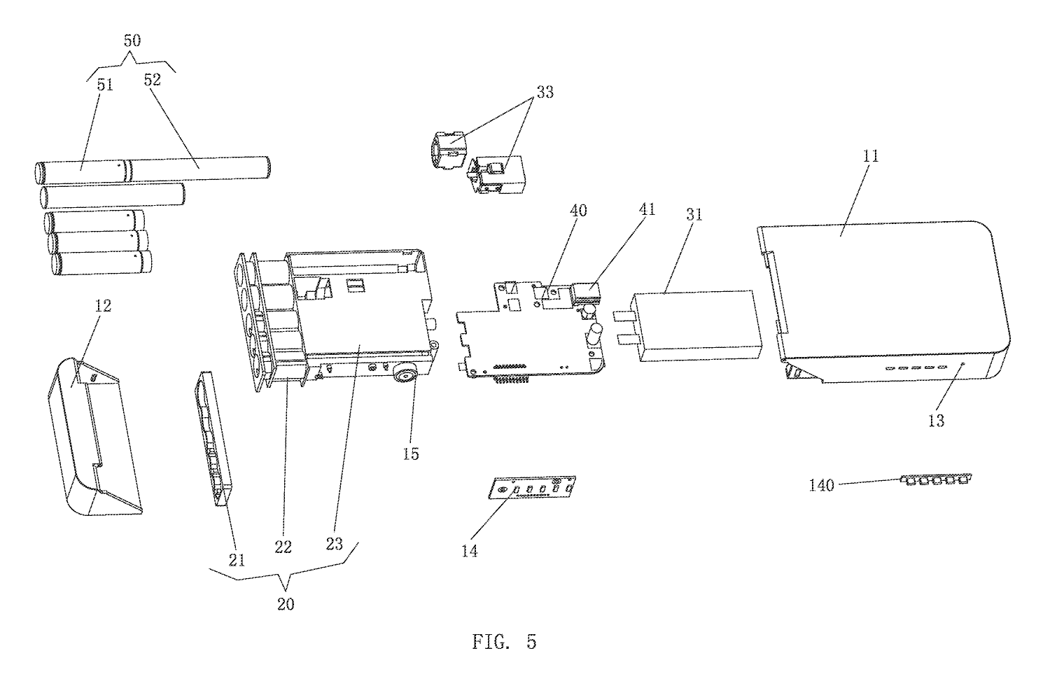

As shown in FIGS. 1-5, an electronic cigarette case 100 and an electronic cigarette device are provided in accordance with an embodiment of the present invention. The electronic cigarette case 100 comprises a case body 10 to accommodate at least on electronic cigarette 50, a frame device 20 installed in the case body 10, a battery device 30, and a printed circuit board (PCB) 40. The electronic cigarette case 100 displays a remaining charge of the battery device 30 via acoustic control. The electronic cigarette device the electronic cigarette case 100 and cartridges 51 and at least one battery rod 52 accommodated in the electronic cigarette case 100.

The case body 10 comprises a bottom case 11 and a case cover 12 movably connected on the bottom case. The case cover 12 is capable of turning toward the bottom case 11. A microphone hole 13 and a display module 14 to display electric quantity are disposed at a lateral side of the case body 10. An audio sensor 15 for detecting external acoustic signals is disposed inside of the case body 10 corresponded to the microphones hole 13 and secured on the PCB 40. In this embodiment, the audio sensor 15 is a mini microphone. The display module 14 is a Liquid Crystal Display (LCD) screen or multiple Light-Emitting Diodes (LEDs). The number of signal bars displayed on the LCD screen and the number of the glowing LEDs represent a rate of the remaining charge. In an embodiment, the acoustic control electronic cigarette case 100 further comprises a light guide plate 140 mounted at outside of the LEDs so as to transmit the light emitted by the LEDs to outside of the case body 10. Besides, the light guide plate 140 also avoids light leakage in other positions and decreases light consumption. A high transmittance protruding cover is provided on the light guide plate 140 corresponding to the LEDs. The protruding cover is beneficial to guide light, fixedly protect and seal the LEDs. The LEDs are accommodated in the protruding cover of the light guide plate 140 and both penetrate through holes of the case body 10 and extend out of the case body 10. Certainly, a corresponding area can be a display window of transparent material; meanwhile, the LEDs are located thereof. Therefore, a surface of the case body 10 is still smoothly.

The frame device 20 comprises a cartridge tray 21, a cartridge frame 22, and a base 23. The cartridge tray 21 is a discoid made of silica gel material to fix and protect the cartridges 51. Multiple openings (not labeled) are provided in the cartridge tray 21 and match with the cartridges 51. The shape of the openings do not limit to a circle. The cartridge frame 22 comprises multiple parallel cylinders (not labeled) which connect to each other collaterally. The inner chambers of the cylinders correspond to the openings of the tray. The cartridge tray 21 covers on the cartridge frame 22 which both support and accommodate the partial cartridges 51 of the at least one electronic cigarette 50. The shape and height of the cartridge tray 21 and the cartridge frame 22 correspond to the cartridges 51 and also match with the shape of the case body 10. Generally, the cartridges 51 are cylindrical; the case body 10 is a rectangle. Accordingly, the cartridge tray 21 is a rectangle tray in this embodiment. The cartridge frame 22 is rectangular. The shape of the cartridge tray 21 and the cartridge frame 22 can be changed based on need. The multiple cartridges 51 respectively insert into the cylinders of the cartridge frame 22 from the circular openings of the cartridge tray 21. Therefore, the cartridges 51 are accommodated in the case cover 12 and a corresponding inner space of the top of bottom case 11. The base 23 is located under the cartridge frame 22 in the bottom case 11. An accommodating space (not labeled) is defined in the base 23.

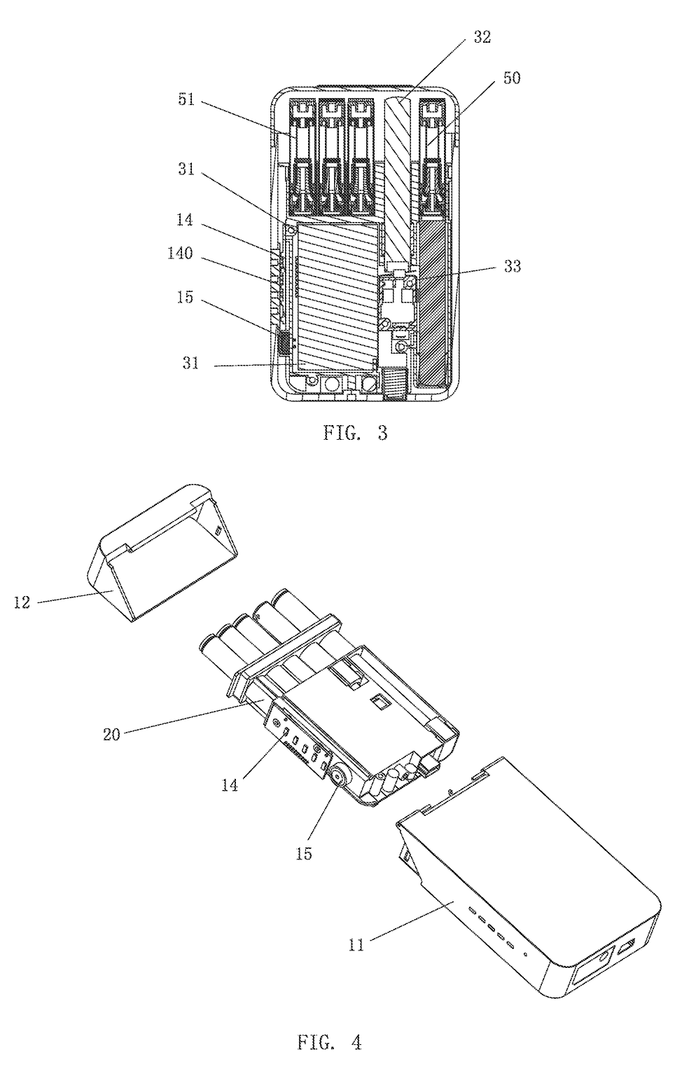

The battery device 30 is a case battery 31 and/or cigarette rod battery 32. The battery device 30 electrically connects the PCB 40 via a battery connector 33. The PCB 40 is secured on the base 23. When the cigarette rod battery 32 is inserted in the accommodating space of the base 23 and electrically connected with the PCB 40 via the battery connector 33, the cigarette rod battery 32 can be recharged via the case battery 31. The at least one electronic cigarette 50 comprises the cartridges 51 and the at least one battery rod 52. The cigarette rod battery 32 is disposed in the at least one battery rod 52. The cartridges 51 comprise smoke media and an atomizer (not shown) to atomize smoke media and turn the smoke media into smoke for smoker. Generally, as shown in FIG. 3, the electronic cigarette case 100 is capable of accommodating the multiple cartridges 51 and one to two battery rods 52 for smoker to use.

A charging interface 41, such as a Universal Serial Bus (USB) interface, is configured on the PCB 40 to recharge the battery device 30 via an external power.

A microprocessor 60 is disposed on the PCB 40 to process acoustic control signals. A memory module 61, an audio processing module 62, an electric quantity detecting module 63 and a display control module 64 are integrated on the microprocessor 60. Referring to an embodiment to be described hereinafter to show how the case battery 31 displays a rate of a remaining charge via acoustic control.

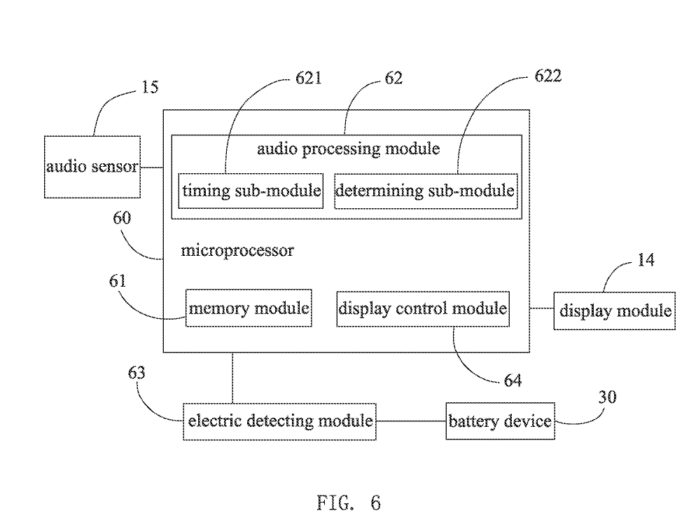

Referring to FIG. 6, another embodiment different from the above-mentioned embodiments, the electric quantity detecting module 63 is an electric detecting circuit disposed on the PCB 40 and connected to the battery device 30. The electric quantity detecting module 63 detects electric quantity of the battery device 30 based on an electric detecting instruction and transmits results to the display control module 64.

The memory module 61 stores a predetermined period of time, and a relation table of electric quantity and display parameters. The predetermined period of time is a time length, such as three seconds or five seconds and so on. The relation table is a matching relation table of the remaining charge and the number of signal bars and the glowing LEDs. For example, there are five LEDs, with one LED representing 1%˜20% remaining charge, and with two LEDs representing 21%˜40% remaining charge, and so on.

The audio processing module 62 connects the audio sensor 15 to generate an electric quantity detecting instruction during the predetermined period of time when the predetermined type acoustic signals is detected. Specifically, the acoustic signals met with the predetermined conditions are invariable, continually strengthening, continually weakening, intermittently strengthening or intermittently weakening acoustic signals. In an embodiment, the audio processing module 62 comprises a timing sub-module 621 connecting with the memory module 61 for counting time based on the predetermined period of time, and a determining sub-module 622 connecting with the audio sensor 15 and the timing sub-module 621 for determining whether the acoustic signals are met with the predetermined conditions during the predetermined period of time. For example, assuming the predetermined period of time is three seconds, smokers blow with an invariable stream to the audio sensor 15; the audio sensor 15 starts to count three seconds time length when detecting acoustic signals. The determining sub-module 622 generates an electric detecting instruction when determining a three seconds invariable acoustic signal.

The electric quantity detecting module 63 connects the audio processing module 62 and the battery device 30 to detect the electric quantity of the battery device 30 based on the electric quantity detecting instruction. It is required to explain that, the electric quantity which the electric quantity detecting module 63 detected is the proportion of the remaining electric quantity in total electric quantity.

The display control module 64 connects the electric quantity detecting module 63 and the memory module 61 for generating a display instruction according to the electric quantity detected by the electric quantity detecting module 63 matched for the relation table. Afterward, the display module 14 displays a current rate of the remaining electric quantity. Therefore, the entire process of displaying the electric quantity is completed. The electronic cigarette case in accordance with the present invention has advantages of being easy to display the electric quantity, durable, rapidly response, space-saving, and practical use.

The above mentioned is only exemplary embodiments of the present invention. It should be noted, for persons of ordinary skill in this art field, improvements and modifications within the spirit of the present invention can be further made, and such improvements and modifications should be seemed to be included in the claimed scope of the present invention.

1. An acoustic control electronic cigarette case, comprising a battery device disposed therein, and wherein the acoustic control electronic cigarette case further comprises:
an audio sensor for detecting external acoustic signals;
a memory module storing a predetermined period of time, and a relation table of electric quantity and display parameters;
an audio processing module connecting with the audio sensor and generating an electric quantity detecting instruction during the predetermined period of time when acoustic signals meeting predetermined conditions are detected;
an electric quantity detecting module connecting with the audio processing module and the battery device, and detecting the electric quantity of the battery device based on the electric quantity detecting instruction;
a display control module connecting with the electric quantity detecting module and the memory module for generating a display instruction according to the electric quantity detected by the electric quantity detecting module matched for the relation table; and
a display module connecting with the display control module for displaying the electric quantity based on the display instruction.

2. The acoustic control electronic cigarette case as claimed in claim 1, wherein the acoustic signals meeting the predetermined conditions are invariable acoustic signals, continually strengthening acoustic signals, continually weakening acoustic signals, intermittently strengthening acoustic signals or intermittently weakening acoustic signals.

3. The acoustic control electronic cigarette case as claimed in claim 1, wherein the audio processing module comprises a timing sub-module connecting with the memory module for counting time based on the predetermined period of time, and a determining sub-module connecting with the audio sensor and the timing sub-module for determining whether the acoustic signals are met with the predetermined conditions during the predetermined period of time.

4. The acoustic control electronic cigarette case as claimed in claim 1, wherein the display module is a liquid crystal display (LCD) screen or multiple light-emitting diodes (LEDs).

5. The acoustic control electronic cigarette case as claimed in claim 4, wherein the acoustic control electronic cigarette case further comprises a light guide plate mounted at outside of the LEDs.

6. The acoustic control electronic cigarette case as claimed in claim 1, wherein the acoustic control electronic cigarette case further comprises a case body comprising a bottom case and a case cover movably connected with the bottom case.

7. The acoustic control electronic cigarette case as claimed in claim 1, wherein the acoustic control electronic cigarette case further comprises a frame device and a printed circuit board (PCB), the frame device comprising a cartridge tray, a cartridge frame and a base, the cartridge tray matching with the cartridge frame to accommodate a cartridge of at least one electronic cigarette, the battery device and the PCB fixed by the base.

8. The acoustic control electronic cigarette case as claimed in claim 7, wherein the battery device is a case battery and/or a cigarette rod battery, the battery device electrically connected with the PCB via a battery connector.

9. The acoustic control electronic cigarette case as claimed in claim 7, wherein a microprocessor is disposed on the PCB, and the memory module, the audio processing module, and the display control module are integrated on the microprocessor.

10. The acoustic control electronic cigarette case as claimed in claim 7, wherein a charging interface is disposed on the PCB for charging the battery device via an external power.

11. An electronic cigarette device, wherein comprises the electronic cigarette case and the cartridges and at least one battery rod accommodated in the electronic cigarette case as claimed in claims 1.
